(19) United States
(12) Patent Application Publication
(10) Pub. No.: US 2008/0316945 A1
(43) Pub. Date: Dec. 25, 2008

(54) IP TELEPHONE TERMINAL AND TELEPHONE CONFERENCE SYSTEM

(76) Inventors: Takeshi Endo, Osaka (JP); Hideki Iizuka, Osaka (JP)

Correspondence Address: MCDERMOTT WILL & EMERY LLP, 600 13TH STREET, NW, WASHINGTON, DC, 20005-3096, US

(21) Appl. No.: 12/143,121

(22) Filed: Jun. 20, 2008

(30) Foreign Application Priority Data
Jun. 21, 2007 (JP) P.2007-163808

(51) Int. Cl. H04L 12/16; H04L 12/66

(52) U.S. Cl. 370/260; 370/352

(57) ABSTRACT

In a telephone conference system including IP telephone terminals for transmitting and receiving packeted and encoded voice information that are connected to each other through an IP network; a storage server for being connected through the IP network and storing the encoded voice information is equipped, a marker assigning unit for generating marker information assigned to the encoded voice information at arbitrary timing is included in the IP telephone terminal; network address information, time information, and the marker information are associated with the encoded voice information to store them in the storage server when the marker information is generated. In addition, an agenda selecting unit is included in the IP telephone terminal, and only the encoded voice information assigned with the marker information corresponding to an agenda selected by the agenda selecting unit is used from the encoded voice information stored in the storage server to reproduce voice.

### BACKGROUND OF THE INVENTION

1. Field of the Invention

The present invention relates to a telephone conference system using IP telephones, and particularly to a voice record and reproduction technique capable of selectively reproducing the stored voice corresponding to a desired content of a proceeding.

2. Description of the Related Art

In a conference, a proceeding is generally written to review the contents of the proceeding later. However, since realistic information is not recorded in a proceeding written in the form of only text information, a speech purpose may not be understood properly when the proceeding written in the form of only the text information is read later. In particular, since a telephone conference depends on only voice, there occurs a problem in that essential information may be omitted in the proceeding written in the form of only the text information. For that reason, as a method of properly reviewing the contents of the conference, recording the speech of a telephone conference is effective.

However, listening to the entire voice recorded in the telephone conference all along is not effective as the method of reviewing the contents of the conference, since it takes much time. Accordingly, in a telephone conference system, there is known a technique capable of partially reproducing desired voice information at the time of reviewing a proceeding in such a manner that the entire telephone voice is recorded, a proceeding is written by automatically converting the voice into text, and attaching link information to the proceeding (for example, see Patent Document 1).

Recently, IP telephones that use a VoIP (Voice over IP) technology for allowing telephone calls to be made over an IP network have started to be spread. The above-described system can be realized even though the IP telephones are not used. However, the telephone conference system using the IP telephones can be realized with more ease and at less cost. In reality, a case where the IP telephones are used in the telephone conference system has been reported as a configuration example of the above-described system.

Patent Document 1: JP-A-2005-33522

However, there occurs a problem in that the entire contents of the proceeding have to be read to search a desired agenda, since the speeches in a conference are output as text information. Moreover, there also occurs a problem in that it is difficult to read sentences in the contents of the proceeding, since a caller speaks to partners in call destinations or the contents contain many quick responses due to the characteristics of a telephone conference.

Since a voice recognition program has to be installed in a server to reproduce the text information, a voice recognition technique with high precision has to be used to exactly reproduce the proceeding. Moreover, even though the voice recognition program with high precision is installed, the voice recognition program has to be trained. For that reason, it is not easy to construct a practical system.

### SUMMARY OF THE INVENTION

The invention is devised in view of such a circumstance, and an object of the invention is to provide a voice record and reproduction technique capable of using the characteristics of an IP telephone, not depending on a proceeding written in the form of only text information at the time of reviewing the contents of a telephone conference, not requiring listening to a voice information record of the telephone conference all along, and selectively reproducing the voice information record of a desired conference content.

According to the invention, there is provided an IP telephone terminal that transmits and receives packeted and encoded voice information and that includes a marker assigning unit that assigns marker information to the encoded voice information. The IP telephone terminals are connected to a storage server over an IP network and the storage server stores the encoded voice information and the marker information assigned by the marker assigning unit by associating them.

With such a configuration, a user of a telephone conference system including the IP telephone terminals and the storage server can allow to the marker assigning unit to assign the marker information to the encoded voice information at any timing (in real time or later). Accordingly, when the marker information is assigned to an agenda, it is possible to identify the contents corresponding to a desired agenda by using the marker information.

According to the invention, the IP telephone terminal may further include an agenda selecting unit and a voice reproducing unit that reproduces voice using the encoded voice information stored in association with the marker information corresponding to the agenda selected by the agenda selecting unit.

With such a configuration, the marker information indicating the start of the agenda is assigned to the encoded voice information and stored in the storage server, and the marker information is assigning by the agenda selecting unit. Accordingly, since a user can select and listen to only the desired agenda, the user can understand the overview of the agenda discussed in the conference without reading the proceeding.

According to the invention, the IP telephone terminal may further include a text information display unit that displays text information converted from the encoded voice information stored in the storage server.

With such a configuration, the text information display unit reads the text information converted from the encoded voice information. Accordingly, a user can select a desired agenda, referring the displayed text information and can select any agenda from a display agenda list to listen to the desired agenda.

In the IP telephone terminal according to the invention, the storage server may store network address information as well as the marker information in association with the encoded voice information. Moreover, the IP telephone terminal may further include a network address assigning unit and a voice reproducing unit that reproduces voice using the encoded voice information associated with the network address information agreeing with the network address assigned by the network address assigning unit.

With such a configuration, a user can select only the speech of a selected participant, since the user can appoint the selected participant by assigning the network address.

In the IP telephone terminal according to the invention, the storage server may store time information as well as the marker information in association with the encoded voice information. Moreover, the IP telephone terminal may further include a timing generating unit and a voice reproducing unit that reproduces voice using the encoded voice information associated with the time information agreeing with the time appointed by the timing generating unit.

With such a configuration, a user can organize a speech order and speech timing in a conference, since the user can control time at the time of reproducing the voice.

According to the invention, the storage server may store network address information and time information as well as the marker information in association with the encoded voice information. Moreover, the IP telephone terminal may further include a speech congestion determining unit that detects congestion of plural speeches and a voice reproducing unit that makes timing of the respective speeches different using the network address information and the timing information and reproduces voice using the encoded voice information to be reproduced, when the speech congestion determining unit detects the congestion of the speeches with respect to the encoded voice information to be reproduced.

With such a configuration, speech timing of every participant can be made different to reproduce the speech, even when the speeches of plural participants are congested. Accordingly, it is difficult to listen to the speech. Accordingly, it is possible to clearly listen to the speech contents of every participant.

According to the invention, the IP telephone terminal may further includes a gain control unit that controls the volume of reproduction voice for every transmission source of the encoded voice information corresponding to voice, when the voice reproducing unit reproduces the voice.

With such a configuration, a volume level of the reproduction voice for every participant can be adjusted. Accordingly, it is possible to reduce displeasure felt due to the fact that the volume of a specific participant is too small or too high.

According to the invention, the IP telephone terminal may further include a voice modulating unit that modulates reproduction voice for every transmission source of the encoded voice information corresponding to voice, when the voice reproducing unit reproduces the voice.

With such a configuration, the voice sound of the reproduction voice for every participant can be adjusted. Accordingly, when voice tones of specific participants are similar to each other and thus make the speeches easily confused, it is possible to reproduce the speech so as to distinguish the speech contents.

According to the invention, only a desired agenda can be selected using assigning marker information indicating the start of an agenda to encoded voice information stored in a storage server and by assigning the marker information by means of an agenda selecting unit. Accordingly, the overview of the conference contents can be easily understood even when a proceeding is not written in the formed of text information. Therefore, the contents of the conference can be effectively reviewed by listening to the desired agenda or the speech of a specific speaker.

### BRIEF DESCRIPTION OF THE DRAWINGS

FIG. 1 is a diagram illustrating a configuration example of a telephone conference system according to a first embodiment of the invention.

FIG. 2 is a diagram illustrating another configuration example of the telephone conference system according to the first embodiment of the invention.

FIG. 3 is a diagram illustrating a configuration example of a telephone conference system according to a second embodiment of the invention.

FIG. 4 is a diagram illustrating a configuration example of a telephone conference system according to a third embodiment of the invention.

FIG. 5 is a diagram illustrating a configuration example of a telephone conference system according to a fourth embodiment of the invention.

FIG. 6 is a diagram illustrating a configuration example of a telephone conference system according to a fifth embodiment of the invention.

FIG. 7 is a diagram illustrating a configuration example of a telephone conference system according to a sixth embodiment of the invention.

FIG. 8 is a diagram illustrating a configuration example of a telephone conference system according to a seventh embodiment of the invention.

### DESCRIPTION OF THE PREFERRED EMBODIMENTS

Hereinafter, a telephone conference system including IP telephone terminals according to exemplary embodiments of the invention will be described with reference to the drawings. In the following description, same Reference Numerals are given to elements having the same function in the exemplary embodiments, and the explanation is omitted.

### First Embodiment

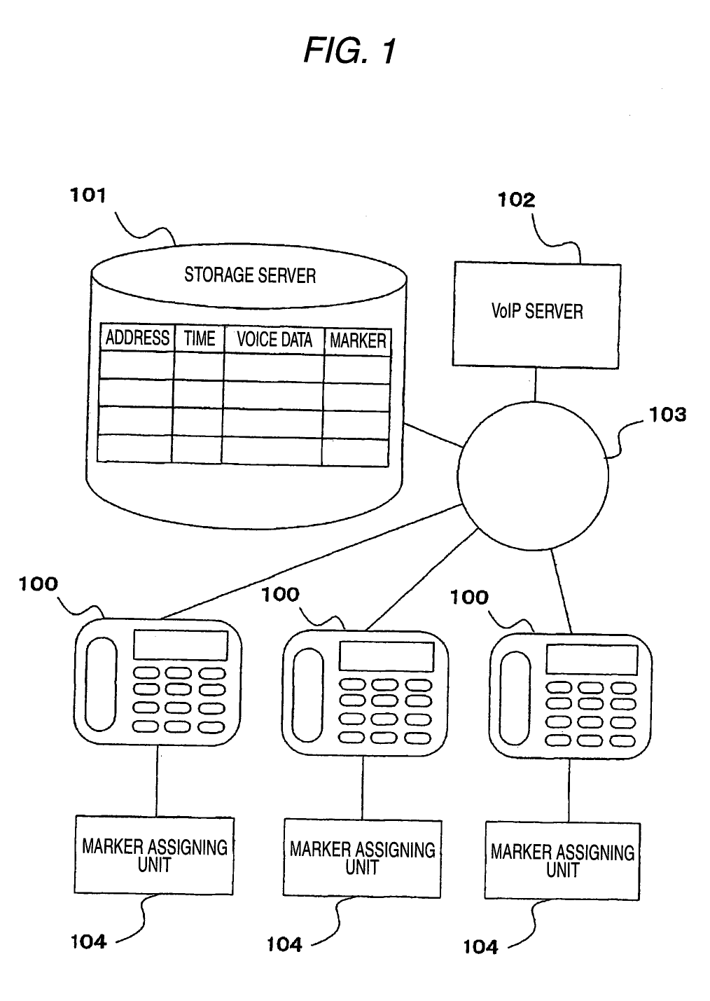

FIG. 1 is a diagram illustrating a configuration example of a telephone conference system according to a first embodiment of the invention. In FIG. 1, Reference Numerals 100 denote IP telephone terminals that perform encoding and packeting voice, and vice versa and that transmit and receive the packeted and encoded voice information (hereinafter, referred to as voice information). Reference Numeral 101 denotes a storage server that stores IP packets and Reference Numeral 102 denotes a VoIP server that performs calling. The IP telephone terminals 100, the storage server 101, and the VoIP server 102 are connected to each other through an IP network 103.

The IP telephone terminals 100 and the VoIP server 102 can communicate with each other using a SIP protocol that is a calling control protocol for IP telephones. In addition, the SIP protocol enables the IP telephone terminals 100 to establish VoIP communication connection. A voice codec technique such as G.711 is used in VoIP communication, but the invention is not limited thereto.

The IP telephone terminal 100 includes a marker assigning unit 104 that can assign marker information to voice information at arbitrary timing. The storage server 101 stores voice information, network address information of the voice information, time information, and the marker information assigned by the marker assigning unit 104, that are transmitted from the IP telephone terminals 100, by associating them. The network address information is identification information used to identify path information of respective terminals within the IP network 103. IP addresses or MAC addresses can be used as the network address information.

In the configuration example, the storage server 101 and the VoIP server 102 are shown as individual elements, but the two functions may be realized by one server.

Assigning a marker to a speech can be performed in real time during telephone conference. Alternatively, the marker may be assigned later while recorded voice is being reproduced. With such a configuration, it is possible to associate the marker information indicating the start of an agenda with the voice information stored in the server. In addition, a speaker in the telephone conference can be identified by the network address information.

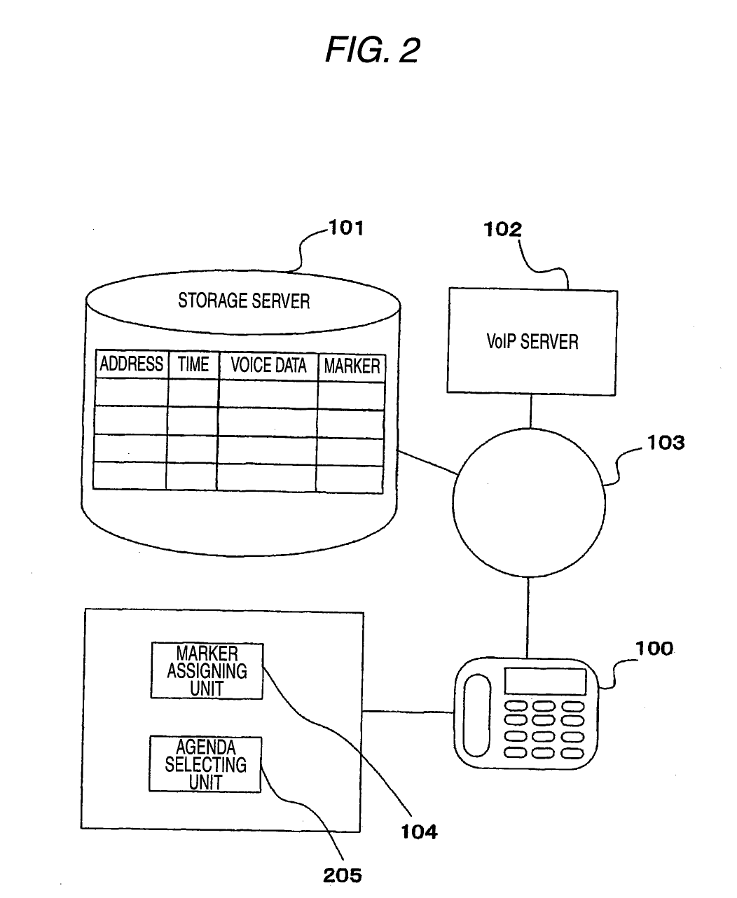

FIG. 2 is a diagram illustrating a configuration example of the telephone conference system according to this embodiment. In the telephone conference system shown in FIG. 2, an agenda selecting unit 205 is further included in the IP telephone terminal 100 shown in FIG. 1. The agenda selecting unit 205 is a unit that selects an agenda desired by a user. A mouse, a keyboard, or the like can be used as the unit to receive input data from the user.

The IP telephone terminal 100 determines whether the marker information associated with the voice information recorded in the storage server 101 is present. The user specifies the voice information assigned with the marker information corresponding to the agenda selected by using agenda selecting unit 205. In addition, the IP telephone terminal 100 reproduces only the voice information assigned with the marker information corresponding to the agenda selected by the agenda selecting unit 205. With such a configuration, since only the desired agenda can be selected and listen, it is possible to understand the overview of an agenda discussed in the telephone conference without listening to the sentences of a proceeding. In addition, the voice information assigned with the marker information corresponding to the agenda selected by the agenda selecting unit 205 of the IP telephone terminal 100 may be reproduced by a voice reproducing apparatus connected to the IP telephone terminal 100.

### Second Embodiment

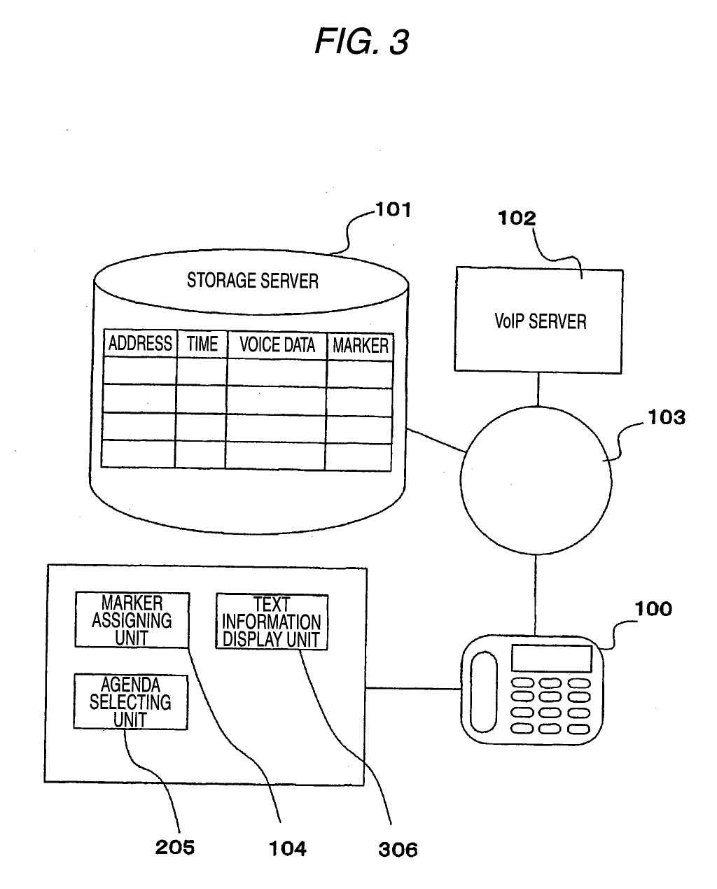

FIG. 3 is a diagram illustrating a configuration example of a telephone conference system according to a second embodiment of the invention. In the telephone conference system shown in FIG. 3, a text information display unit 306 is further included in the IP telephone terminal 100 shown in FIG. 2.

The IP telephone terminal 100 acquires the voice information assigned with marker information from the storage server 101. The text information display unit 306 converts the acquired voice information into text information to display it. The converting of the voice information into the text information may be performed by the storage server 101, and the text information display unit 306 may just perform displaying. With such a configuration, when the marker information indicating the start of an agenda is assigned to the voice information, only an agenda in a telephone conference can be extracted and displayed in the text information display unit 306. Accordingly, a user can reproduce only a desired agenda using the agenda selecting unit 205, referring the displayed text information.

### Third Embodiment

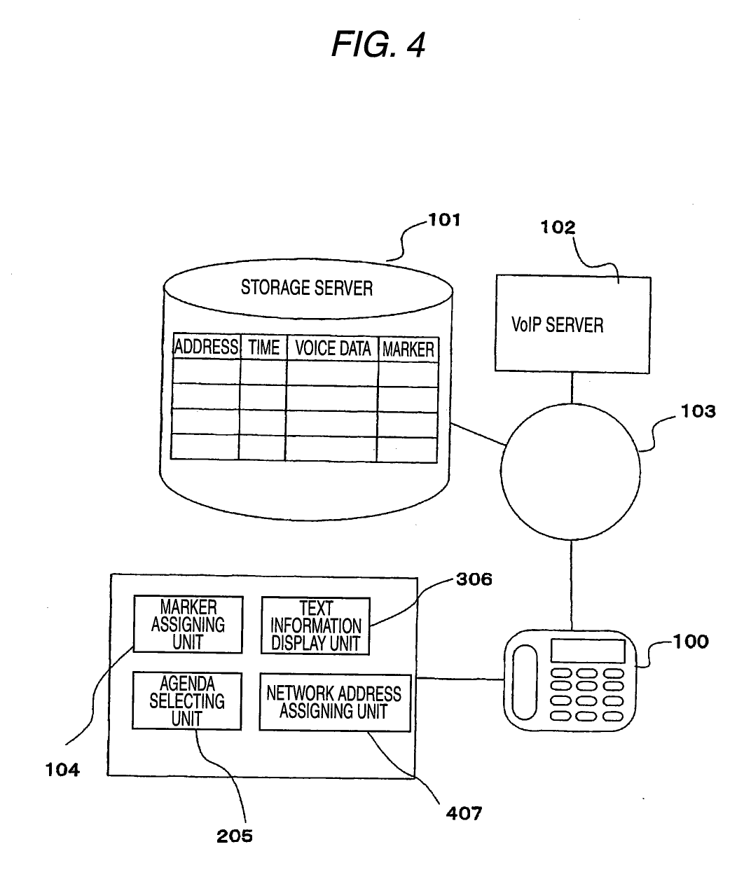

FIG. 4 is a diagram illustrating a configuration example of a telephone conference system according to a third embodiment of the invention. In the telephone conference system shown in FIG. 4, a network address assigning unit 407 is further included in the IP telephone terminal 100 shown in FIG. 3. The network address assigning unit 407 is a unit in that a user assigns a participant using a network address. A mouse, a keyboard, or the like can be used to receive input data from the user.

The network address assigning unit 407 may have a function capable of changing network addresses simply listed by numbers into different names. The IP telephone terminal 100 acquires voice information containing the network address information agreeing with the network address specified by the user from the storage server 101 to reproduce the voice. With such a configuration, the user of the telephone conference system can specify any participant and listen to only the speech of the participant.

### Fourth Embodiment

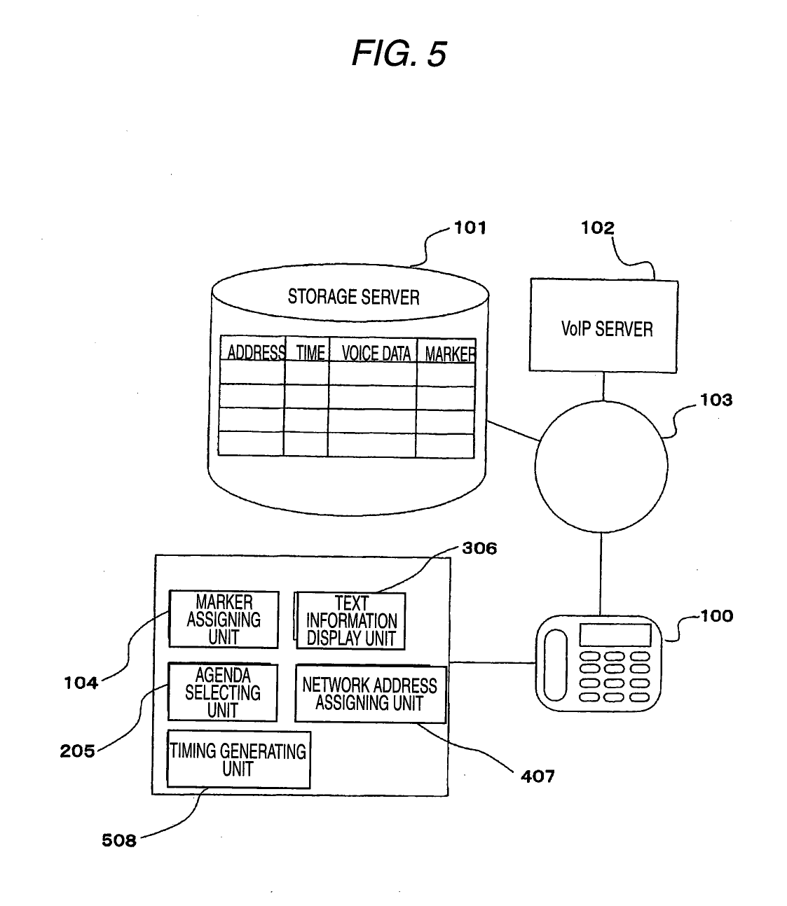

FIG. 5 is a diagram illustrating a configuration example of a telephone conference system according to a fourth embodiment of the invention. In the telephone conference system shown in FIG. 5, a timing generating unit 508 is further included in the IP telephone terminal 100 shown in FIG. 4. As the timing generating unit 508, a clock oscillator equipped in a general information processing apparatus or a clock server on the Internet may be used.

The IP telephone terminal 100 acquires voice information while synchronizing time information generated by the timing generating unit 508 and time information stored in the storage server 101. With such a configuration, a user of the telephone conference system can listen to reproduction voice while reproducing a speech order or speech timing.

### Fifth Embodiment

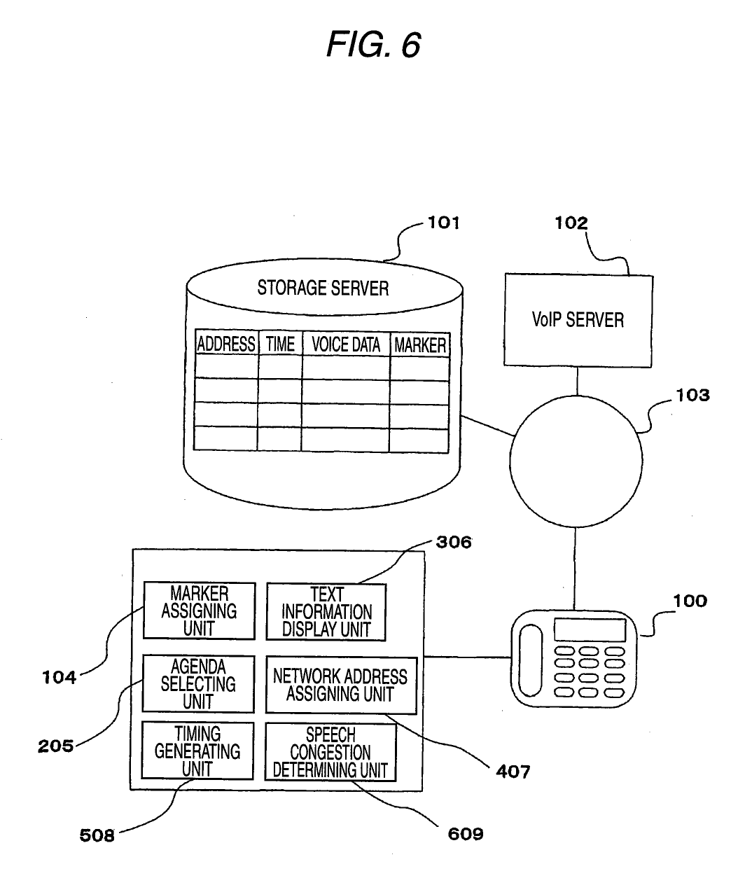

FIG. 6 is a diagram illustrating a configuration example of a telephone conference system according to a fifth embodiment of the invention. In the telephone conference system shown in FIG. 6, a speech congestion determining unit 609 is further included in the IP telephone terminal 100 shown in FIG. 5. The speech congestion determining unit 609 can determine whether speeches are overlapped with each other on a time axis using time information of the speeches and the length of the speeches, or the network address information.

The IP telephone terminal 100 can make reproduction timing of the speeches different using the network address information and the time information, when the speech congestion determining unit 609 detects congestion of the speeches with respect to the encoded voice information to be reproduced. With such a configuration, it is possible to clearly listen to the contents of the speeches by making the reproduction timing different, even when the speeches of plural participants are congested, and thus it is difficult to listen to the contents of the speeches.

### Sixth Embodiment

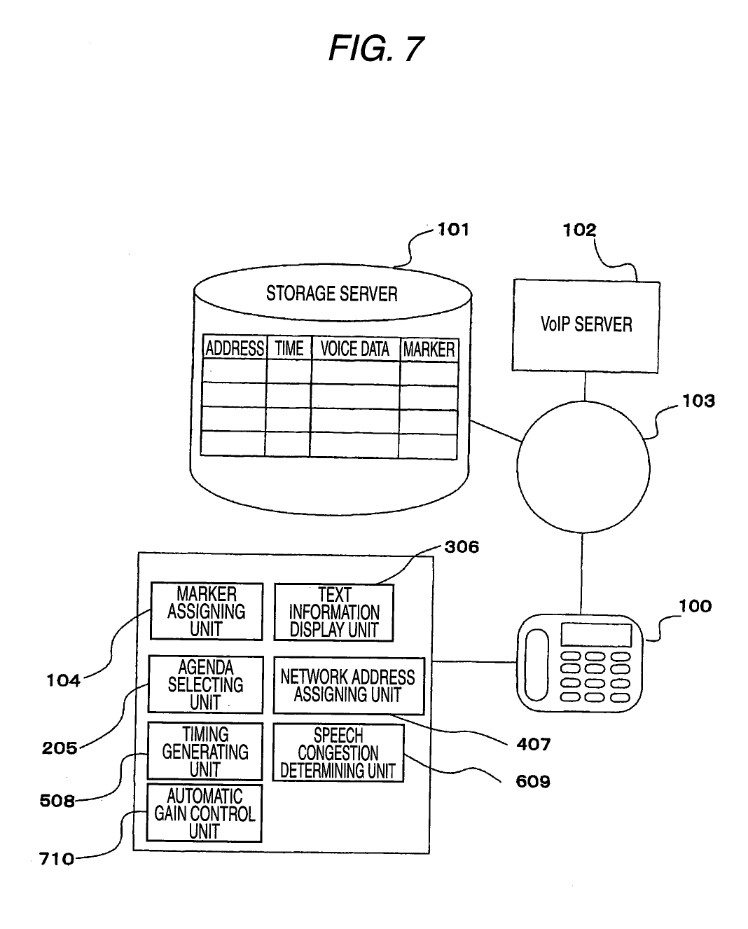

FIG. 7 is a diagram illustrating a configuration example of a telephone conference system according to a sixth embodiment of the invention. In the telephone conference system shown in FIG. 7, an automatic gain control unit 710 is further included in the IP telephone terminal 100 shown in FIG. 6.

The automatic gain control unit 710 can adjust volume levels of the respective voice information for every transmission source in a different manner each other, when the IP telephone terminal 100 reproduces the voice information. It is possible to improve the reproduction voice so as to easily listen to the reproduction voice by equalizing the different volume levels of every transmission source using the automatic gain control unit 710.

### Seventh Embodiment

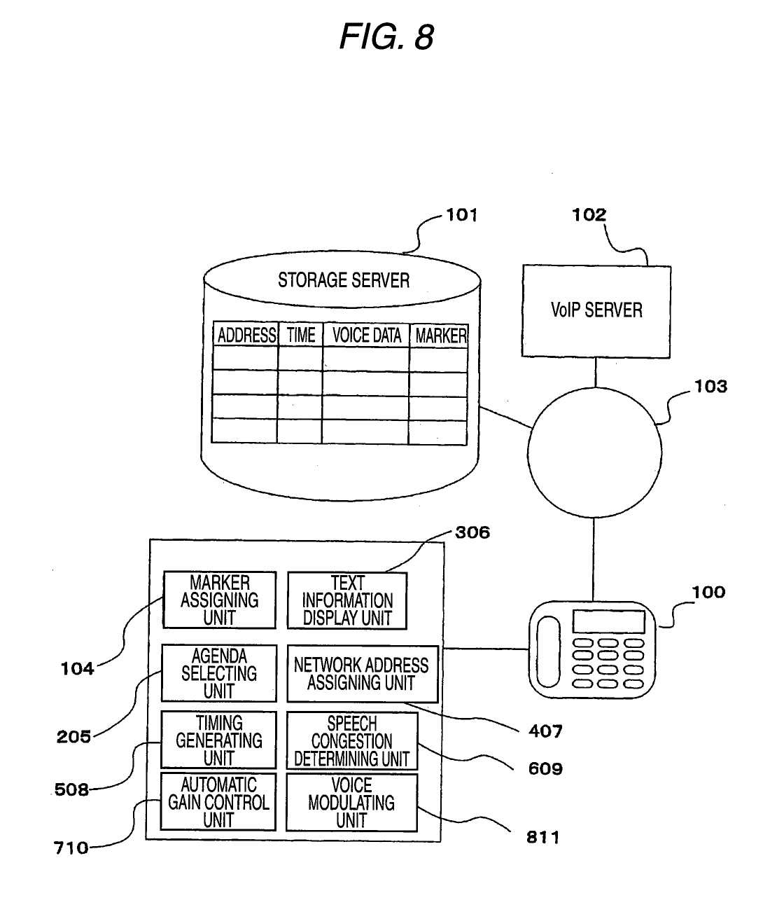

FIG. 8 is a diagram illustrating a configuration example of a telephone conference system according to a seventh embodiment of the invention. In the telephone conference system shown in FIG. 8, a voice modulating unit 811 is further included in the IP telephone terminal 100 shown in FIG. 7.

The voice modulating unit 811 can modulate reproduction voice for every transmission source when the voice information is reproduced. For example, it is possible to increase the voice tone of respective specific speakers by using the voice modulating unit 811 at the time of reproduction. With such a configuration, a user can clearly listen to the speeches at the time of reproduction, even when the speeches are confused due to the similarity of the voice tones of the specific speakers.

The invention provides advantages in that the overview of conference contents in a conference without making a proceeding in the form of text information, the contents in the conference can be effectively reviewed by selecting only a specific speaker or a desired agenda, and the speeches of many speakers at plural destinations in a telephone conference can be easily improved so as to easily listen. Moreover, the invention is effective in a telephone conference system using IP telephone terminals.

What is claimed is:

1. An IP telephone terminal that transmits and receives packeted and encoded voice information, comprising:
a marker assigning unit that assigns marker information to the encoded voice information,
wherein the IP telephone terminals are connected to a storage server over an IP network, the storage server storing the encoded voice information and the marker information assigned by the marker assigning unit by associating them.

2. The IP telephone terminal according to claim 1, further comprising:
an agenda selecting unit; and
a voice reproducing unit that reproduces voice using the encoded voice information stored in association with the marker information corresponding to the agenda selected by the agenda selecting unit.

3. The IP telephone terminal according to claim 1, further comprising a text information display unit that displays text information converted from the encoded voice information stored in the storage server.

4. The IP telephone terminal according to claim 1, wherein the storage server stores network address information as well as the marker information in association with the encoded voice information, and
wherein the IP telephone terminal further comprises:
a network address assigning unit; and
a voice reproducing unit that reproduces voice using the encoded voice information associated with the network address information agreeing with the network address assigned by the network address assigning unit.

5. The IP telephone terminal according to claim 1,
wherein the storage server stores time information as well as the marker information in association with the encoded voice information, and
wherein the IP telephone terminal further comprises:
a timing generating unit; and
a voice reproducing unit that reproduces voice using the encoded voice information associated with the time information agreeing with the time appointed by the timing generating unit.

6. The IP telephone terminal according to claim 1,
wherein the storage server stores network address information and time information as well as the marker information in association with the encoded voice information,
wherein the IP telephone terminal further comprises:
a speech congestion determining unit that detects congestion of plural speeches; and
a voice reproducing unit that makes timing of the respective speeches different using the network address information and the timing information and reproduces voice using the encoded voice information to be reproduced, when the speech congestion determining unit detects the congestion of the speeches with respect to the encoded voice information to be reproduced.

7. The IP telephone terminal according to any one of claims 2, 4, 5, and 6, further comprising a gain control unit that controls the volume of reproduction voice for every transmission source of the encoded voice information corresponding to voice, when the voice reproducing unit reproduces the voice.

8. The IP telephone terminal according to any one of claims 2, 4, 5, and 6, further comprising a voice modulating unit that modulates reproduction voice for every transmission source of the encoded voice information corresponding to voice, when the voice reproducing unit reproduces the voice.

9. The telephone conference system comprising the IP telephone terminals according to claim 1 and a storage server.
